(19) United States
(12) Patent Application Publication
(10) Pub. No.: US 2009/0034232 A1
(43) Pub. Date: Feb. 5, 2009

(54) FUEL DISPENSING UNIT HOUSING

(76) Inventors: Bengt I. Larsson, Skivarp (SE); Annika Birkler, Malmo (SE); Marlene Wemmert, Malmo (SE)

Correspondence Address: FISH & RICHARDSON P.C., P.O. BOX 1022, MINNEAPOLIS, MN, 55440-1022, US

(21) Appl. No.: 12/141,477

(22) Filed: Jun. 18, 2008

(30) Foreign Application Priority Data
Jun. 20, 2007 (EP) 07110682.7

(51) Int. Cl. F21V 33/00; B67D 5/12; B65D 5/66

(52) U.S. Cl. 362/96; 222/74; 222/113; 362/101

(57) ABSTRACT

A housing for a fuel dispensing unit comprises a top part, a bottom part and at least one column extending between the bottom part and the top part. Said bottom part comprises a light emitting device arranged to emit light, and said top part comprises a light directing device for directing the emitted light towards the bottom part.

### CLAIM OF PRIORITY

Under 35 U.S.C. § 119, this application claims the benefit of a foreign priority application filed in the European Patent Convention, serial number 07110682.7, filed Jun. 20, 2007, the entire contents of which are hereby incorporated by reference.

### TECHNICAL FIELD

The present invention relates to a housing for a fuel dispensing unit, comprising a top part having light directing means, a bottom part having light emitting means, and at least one column extending between the bottom part and the top part. The present invention also relates to a fuel dispensing unit comprising such housing.

### BACKGROUND

A fuel dispensing unit typically comprises a pump or fuel dispenser part standing on the ground, a display part positioned above the pump part and showing the chosen type of petrol (gasoline), cash readout, volume readout etc., and a column to which one or more petrol hoses are connected.

Typically, a fuel dispensing unit is also equipped with other electronics, i.e. means for choosing the desired fuel and a payment terminal. In general, these features are electrical. Since the physical height of the fuel dispensing unit is rather large, some of the above mentioned electrical features and the display part are positioned in the mid or lower part of the fuel dispensing unit, such as adjacent to and on top of the pump part. Such electronic equipment, arranged in the vicinity of the fuel handling parts of the fuel dispensing unit, must be securely encapsulated in order to prevent ignition of flammable gases.

It is often desirable in the art to light the exterior of a fuel dispensing unit as well as the area surrounding the unit. This is particularly preferred during the hours of darkness, so that a person using the fuel dispensing unit can recognize unit handling means such as the hose, pump nozzle, octane selector, unit display etc. A fuel dispensing unit may be fitted with a payment terminal which must be lit up in order to facilitate user interaction. It is also desirable to light up a vehicle that is to be refuelled including the ground surrounding the vehicle. Other equipment common at a filling stations, such as trash cans, paper holders and buckets with windscreen scrapers etc, must be clearly visible. The light itself is also used as a means to attract customers, expose trademarks, provide safety and give a welcoming feeling in the hours of gloom or darkness.

Several techniques for lighting up fuel dispensing units are known in the art. One known fuel dispenser lighting arrangement includes a fuel dispenser with an upper lighting part, a lower fuel handling part and side parts connecting the upper part and the lower part. The upper lighting part has an internal fluorescent lamp. The upper lighting part is further equipped with translucent top, bottom, front, rear and side members in the form of flat panels. When the light source is activated, light will be emitted through the translucent members, and will hence provide illumination of the fuel dispensing unit and its surroundings.

For many pumps on the market today, the hoses are connected to the fuel dispensing unit where the top member is connected to the side parts. Thus, there are joints present at the upper part which may lead to leakage of flammable fuel gases. Flammable gases might, for example, also be transported from hydraulic pump components in the lower fuel handling part through the side parts to the upper lighting part.

Therefore, an inconvenience of the described fuel dispensing unit is that it requires certain certified electronic equipment to be installed together with the fluorescent lamp. Such certified equipment is more expensive and more difficult to get hold of as compared to standard electronic components.

It is thus desirable in the art to have a fuel dispensing unit that is visible in the dark, yet has reduced risk of fire or explosion. It is also desirable to have a housing which may use standard electronic components and may not need advanced security arrangements.

### SUMMARY OF THE INVENTION

In one aspect, the housing for a fuel dispenser disclosed herein comprises a top part, a bottom part and at least one column extending between the bottom part and the top part; said bottom part comprises a light emitting device arranged to emit light, and said top part comprises a light directing device for directing the emitted light towards the bottom part. This is advantageous in that standard light emitting means may be used. Fuel dispensing units comprising a bottom part are generally equipped with electronics in said bottom part. Such electronics are already securely mounted using safe encapsulations, whereby further addition of light emitting means is provided without extra security arrangements. Further, advanced cable run may be avoided and the changing of light emitting means is made simpler.

The light directing device may be a reflective means, which is advantageous in that light is directed in a simple way.

The light directing device may be a fibre optical cable, which is advantageous in that light is directed in a efficient way.

The light emitting device may be a light bulb, a spotlight, a fluorescent tube or a light emitting diode. Thus, conventional light sources are used.

The light emitting device may also be covered by a light diffusive panel, whereby the directed light is made more uniform.

According to another aspect of the invention, a fuel dispensing unit comprising a housing according to the first aspect of the invention is provided. The advantages of the first aspect are also applicable for this second aspect of the invention.

### BRIEF DESCRIPTION OF THE DRAWINGS

The invention will now be described with reference to the drawings, in which:

FIG. 1 is a perspective view of a housing according to one embodiment of the invention.

FIG. 2 is a front view of parts of the housing according to one embodiment of the invention.

FIG. 3 is a top view of the bottom part of a housing according to another embodiment of the invention.

FIG. 4 is a top view of the bottom part of a housing according to yet another embodiment of the invention.

FIG. 5 is a top view of the bottom part of a housing according to another embodiment of the invention.

FIG. 6 is a front view of parts of the housing according to another embodiment of the invention.

### DETAILED DESCRIPTION

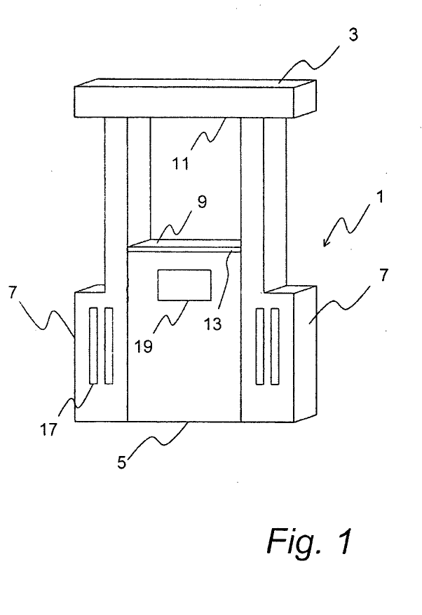

As shown in FIG. 1, a housing 1 is adapted to form the exterior of a fuel dispensing unit. The housing 1 has a top part 3, a bottom part 5 and two columns 7 which are extending vertically between the bottom part 5 and the top part 3. The bottom part 5 encloses fuel handling means such as a pump, flow meter, etc. (not shown). The two columns 7 are arranged to provide hose handling and storage means (not shown) and pump nozzle handling and storage means 17. The bottom part 5 has a pump display 19 which may also include a payment terminal (not shown).

As shown, the upper portion of the bottom part 5 comprises a light emitting device 9 which emits light. The light emitting device is at least one light source, e.g. a light bulb, a spot light, a fluorescent tube or a light emitting diode (LED). In case of LEDs, the light emitting device can comprise several LEDs of different colors (e.g. red, green and blue) and a control unit for adjusting the relative amount of light intensity emitted from each LED. Thus, the color of the emitted light may be controlled.

The light emitted from the light emitting device 9 is directed by a light directing device 11, positioned in the top part 3 of the housing 1.

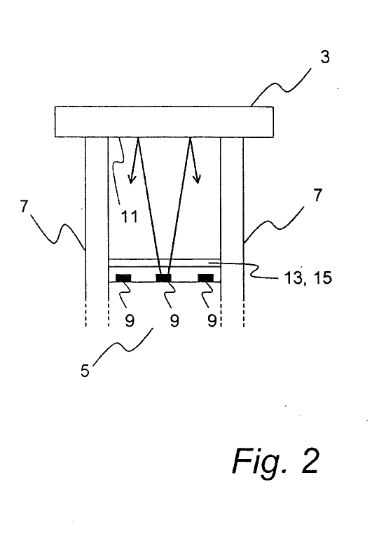

In FIG. 2, a first embodiment of the housing 1 is shown. In the upper portion of the bottom part 5, a plurality of light sources 9 are arranged. The light sources 9, which may be of any per se known type, are emitting light in a direction towards the top part 3 (indicated by arrows). The light emitted from said light sources 9 is incident on an upper panel 15 of the bottom part 5. The upper panel 15, as shown, has a translucent portion 13; from which portion the emitted light is extracted. The extracted light propagates towards the top part 3 and is directed by the directing device 11.

The directing device is a light reflector, such as a mirror. The mirror may be concave, convex, or of any other shape suitable for directing light towards the fuel dispensing unit and its surroundings. The light reflector can also be arranged as a plurality of small mirrors.

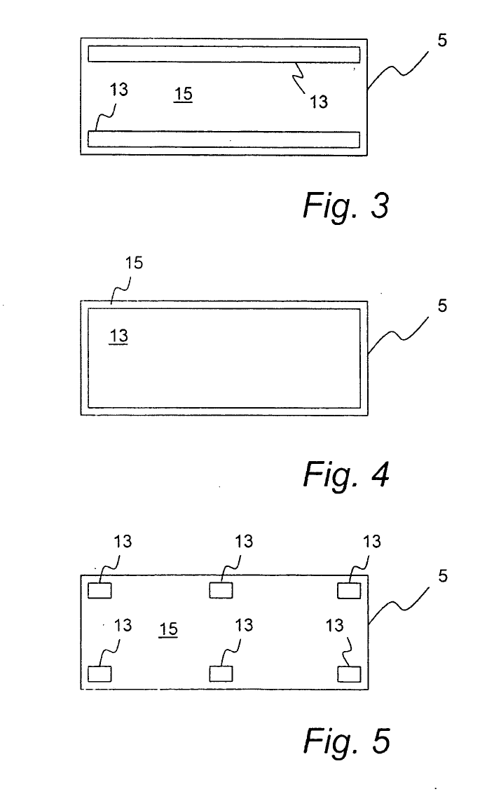

In FIGS. 3, 4 and 5 different embodiments of the upper panel 15 of the bottom part 5 are shown. As shown in FIG. 3, the upper panel 15 has two translucent portions 13, from which portions 13 emitted light is extracted. In FIG. 4, the translucent portion 13 is covering a major part of the upper panel 15. In FIG. 5 several translucent portions 13 are distributed in the upper panel 15.

The translucent portion/portions 13 are made by optically clear or optically diffusive material. The portions 13 can also be colored, so that light of one or more desired colors are transmitted.

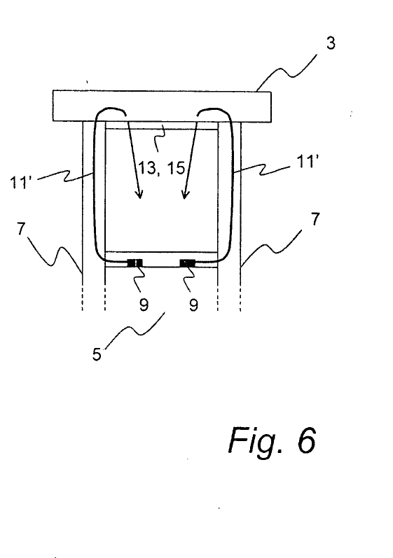

FIG. 6 shows another embodiment of the housing 1. Here, the light sources 9 are directed to emit light into light guides 11′ which are optically connected to the light sources 9. The light guides 11′ are directing the emitted light along the columns 7 and to the top part 3. As shown, the top part 3 has an upper panel 15 including a translucent portion 13. The light directed by said light guides 11′ is extracted from the light guides 11′ in a direction towards the upper panel IS and the extracted light is transmitted through the translucent portions 13. Thus, the transmitted light is illuminating the fuel dispensing unit and its surroundings.

The light guides 11′ can be optical fibres or similar. In a further embodiment of the housing 1, the light guides 11′ are arranged to also emit light out from the columns 7. Thus, one or several translucent portions are positioned at the inner side of the columns 7 and a corresponding amount of light guides 11′ are arranged to end adjacent to said translucent portions so that light is extracted out from the translucent portions.

Other embodiments are within the scope of the following claims.

1. A housing for a fuel dispensing unit, comprising a top part, a bottom part and at least one column extending between the bottom part and the top part, wherein
said bottom part comprises a light emitting device, and
said top part comprises a light directing device for directing light emitting from the light emitting device towards the bottom part.

2. A housing according to claim 1, wherein the structure adapted to direct light comprises a reflector.

3. A housing according to claim 1, wherein the structure adapted to direct light is a fibre optical cable.

4. A housing according to claim 1, wherein the light emitting device is a light bulb, a spotlight, a fluorescent tube or a light emitting diode.

5. A housing according to claim 1, wherein the light emitting device is covered by a light diffusive panel.

6. A fuel dispensing unit comprising
a nozzle,
a hose,
a boot adapted to receive the nozzle,
a housing for a fuel dispensing unit, comprising a top part, a bottom part and at least one column extending between the bottom part and the top part, wherein
said bottom part comprises a light emitting device, and
said top part comprises a light directing device for directing light emitting from the light emitting device towards the bottom part.
